(19) United States
(12) Patent Application Publication
(10) Pub. No.: US 2024/0347763 A1
(43) Pub. Date: Oct. 17, 2024

(54) GLASS SOLID ELECTROLYTE LAYER, METHODS OF MAKING GLASS SOLID ELECTROLYTE LAYER AND ELECTRODES AND BATTERY CELLS THEREOF

(71) Applicant: PolyPlus Battery Company, Berkeley, CA (US)

(72) Inventors: Steven J. Visco, Berkeley, CA (US); Vitaliy Nimon, Berkeley, CA (US); Valentina Loginova, Berkeley, CA (US); Yevgeniy S. Nimon, Berkeley, CA (US); Bruce D. Katz, Berkeley, CA (US)

(21) Appl. No.: 18/671,767

(22) Filed: May 22, 2024

Related U.S. Application Data
(62) Division of application No. 17/303,706, filed on Jun. 4, 2021, now Pat. No. 12,034,116.
(60) Provisional application No. 62/706,416, filed on Aug. 14, 2020.
(60) Provisional application No. 63/064,945, filed on Aug. 13, 2020.
(60) Provisional application No. 63/061,121, filed on Aug. 4, 2020.

(51) Int. Cl. H01M 10/0562; C03C 15/00; H01M 10/0525

(52) U.S. Cl. CPC H01M 10/0562; C03C 15/00; H01M 10/0525; H01M 2300/0068

(57) ABSTRACT

Battery component structures and manufacturing methods for solid-state battery cells include a unitary Li ion conducting sulfide glass solid electrolyte structure that serves as the basic building block around which a solid-state battery cell can be fabricated. The unitary glass structure approach can leverage precision controlled high throughput processes from the semiconductor industry that have been inventively modified as disclosed herein for processing a sulfide glass solid electrolyte substrate into a unitary Li ion conducting glass structure, for example, by using etching and lithographic photoresist formulations and methods. The glass substrate may be precision engineered to effectuate a dense glass portion and a porous glass portion that can be characterized as sublayers having predetermined thicknesses. The porous glass sublayer includes a plurality of discrete substantially vertical closed-end holes or trenches that are precision engineered into one or both major substrate surfaces using microfabrication processes.

### STATEMENT OF GOVERNMENT SUPPORT

This invention was made with Government support under Award No.: DE-AR0000772 awarded by the Advanced Research Projects Agency—Energy (ARPA-E), U.S. Department of Energy. The Government has certain rights in this invention.

### CROSS-REFERENCE TO RELATED APPLICATIONS

An Application Data Sheet is filed concurrently with this specification as part of the present application. Each application that the present application claims benefit of or priority to as identified in the concurrently filed Application Data Sheet is incorporated by reference herein in its entirety and for all purposes.

### BACKGROUND

### 1. Field

This disclosure relates to batteries, and in particular to a battery electrode, separator electrode assembly, and battery cell that is based on a unitary structure of Li ion conducting sulfide glass. In various embodiments the electrode or battery cell is fully solid-state, and in particular embodiments wholly inorganic.

### 2. Description of Related Art

All solid-state batteries (ASSBs) have the potential to offer enhanced energy density and improved safety over conventional lithium-ion batteries. The various battery types may be differentiated by the composition and/or atomic structure of the solid electrolyte. For instance, categories may include solid polymer electrolytes, sulfide electrolytes (e.g., crystalline, glass, glass-ceramic), and oxide electrolytes (e.g., LLZO and LATP).

In particular, Li metal ASSBs hold the promise of exceptional specific energy and energy density. To achieve such high energy density, it has been reported that thick voluminous cathodes should be used as a battery substrate that provides mechanical support and allows for current collectors and lithium metal to be applied as thin coatings. However, thick composite or dense cathodes based on lithium metal oxide or phosphate intercalation compounds (e.g., LCO, NMC, NCA, LFP) are oftentimes hindered by poor ion transport into the depth of the cathode thickness, which limits the rates at which such an ASSB may be discharged and charged.

For electric vehicle applications, rate performance and low manufacturing costs are paramount. Accordingly, there remains a need for an improved method of manufacture and solid-state cell structures that are not limited by ion diffusion through a thick cathode substrate and can be manufactured at low cost.

### SUMMARY

Disclosed are battery component structures and manufacturing methods for solid-state battery cells. In particular, a unitary Li ion conducting sulfide glass solid electrolyte structure is provided that serves as the basic building block around which a solid-state battery cell of the present disclosure is fabricated. In various embodiments, the unitary glass structure approach provided herein includes a method for making a solid-state battery cell that is based on a sulfide glass substrate having a precision engineered microstructure with highly anisotropic closed-end circular holes that form a regular hole pattern on the substrate surface. Moreover, some of the methods disclosed herein can leverage precision controlled high throughput processes from the semiconductor industry that have been inventively modified as disclosed herein for processing a sulfide glass solid electrolyte substrate into the instant unitary Li ion conducting glass structure, for example, by using etching and lithographic photoresist formulations and methods of the present disclosure. In one aspect the present disclosure provides a unitary Li ion conducting glass structure that is employed in a solid-state battery and serves as the basic building block for making a solid-state battery cell. In accordance with this aspect, the unitary glass structure is composed of a Li ion conducting sulfide glass monolith, typically in the form of a substantially flat glass substrate having first and second opposing major surfaces. The glass substrate may be precision engineered to effectuate a dense glass portion and a porous glass portion that are layer-like in the sense that the dense and porous portions have defined thickness across the structure and so can be characterized as sublayers having predetermined thicknesses. The porous glass sublayer includes a plurality of discrete substantially vertical closed-end holes or trenches that are precision engineered into one or both major substrate surfaces using microfabrication processes. In various embodiments the holes or trenches are formed using one or more etching processes of the present disclosure and, in particular embodiments, a predetermined and regular hole or trench pattern is created by combining etching with specialized masking and/or lithographic methods. For example, a substantially periodic or patterned array of high aspect ratio closed end holes may be lithographically etched into a Li ion conducting sulfide glass in accordance with these methods. Moreover, because the holes are made from the substrate surface, the methods described herein give rise to a planar surface hole or trench pattern that corresponds to, but may not exactly mimic, the hole and trench microstructure within the depth of the substrate. The surface hole pattern is pre-determined by the hole pattern of the mask or photoresist. In various embodiments it is contemplated that the circular hole pattern is regular with periodically spaced apart holes. However, hole pattern designs are contemplated that produce irregular circular hole patterns.

In accordance with the present disclosure the Li ion conducting unitary sulfide glass structures described herein are unitary in the sense that it is a single continuous material that is made by engineering microstructures into a single continuous substrate of Li ion conducting sulfide glass, as opposed to a structure that is composed of several material layers bonded together to form a structure. As a single continuous structure, there are no layer boundaries that could manifest as a grain boundary or bonding boundary.

In accordance with the present disclosure the Li ion conducting sulfide glass substrate is composed of Li ion conducting inorganic sulfide glass, which may be single phase or multi-phase. Li ion conducting glasses are generally composed of one or more glass network formers (e.g., SiS2, B2S3, P2S5) and one or more glass network modifiers (e.g., Li2S, Li2O) and in some embodiments a dopant may be used for benefit such as to enhance conductivity and/or chemical stability (e.g., LiCl, LiI, Li3PO4). Inorganic sulfide glasses and sulfide glass sheets suitable for use herein as a Li ion conducting glass substrate for making a unitary Li ion conducting glass structure of the present disclosure are described in U.S. Pat. No. 10,164,289, hereby incorporated by reference.

In accordance with the present disclosure, the substantially vertical holes or trenches are formed from a major surface of the sulfide glass substrate to a predetermined depth within its bulk. Accordingly, the holes and trenches are “closed-end” by which it is meant that they do not penetrate the substrate to form a through hole or through slot. In various embodiments the closed-end holes or trenches, in addition to being vertically closed (i.e., not forming a through hole or slot) are also closed laterally by sidewall surfaces, and therefore the only surface opening of such holes or trenches is the open end on the substrate surface from which it was formed (i.e., the etching surface). Depending on the etching methods and microfabrication processes employed, the characteristic dimensions and shape of the holes and trenches may vary with penetration depth, and thus may not mimic the dimensions and shapes at the surface. In various embodiments the holes are circular. However, other hole shapes are contemplated including square, oval, triangular and rectangular holes (i.e. trenches). Combinations of different shaped holes are also contemplated.

In various embodiments, the unitary glass structure of the present disclosure is incorporated in a battery cell as a multifunctional component with both separator and electrode functionality, and, in such instances, as described herein below, the size and shape of the holes and trenches are suitable for receiving and accommodating electroactive material for the purpose of providing ampere-hour capacity in the battery in which the unitary glass structure is employed, with its holes and/or trenches filled with cathode or anode active material.

In various embodiments the unitary glass structure is a substantially flat Li ion conducting sulfide glass substrate having a plurality of closed-end holes or trenches that have been engineered into the substrate in such a manner as to be characterizable as having a asymmetric architecture composed of two sublayers each having a characteristic and predetermined sublayer thickness: i) a dense glass sublayer that extends into the substrate from the substrate second major surface; and ii) a porous glass sublayer with precision engineered closed-end holes and/or trenches that extend into the substrate from the substrate first major surface.

In various embodiments the unitary glass structure is a substantially flat Li ion conducting sulfide glass substrate characterizable as having a sandwich architecture composed of three sublayers each having a characteristic thickness: i) a first porous glass sublayer with precision engineered trenches defining the substrate first major surface; ii) a second porous glass sublayer with precision engineered trenches defining the substrate second major surface; and iii) a dense glass sublayer sandwiched between the first and second porous glass sublayers.

In various embodiments it is beneficial in order to prevent adverse reactions to the manufacturing environment (e.g., moisture) and/or battery component materials (e.g., electroactive material) to apply (e.g., by coating) a protective layer onto surfaces of the unitary Li ion conducting glass structure, including a conformal protective layer that coats the sidewall and bottom surfaces of the holes or trenches. For example, chemical vapor deposition (CVD) techniques, including atomic layer deposition (ALD) are particularly well suited for conformal coating, other techniques are also contemplated including solution and sol gel coating methods.

In other aspects the present disclosure provides a separator electrode assembly and a battery cell wherein the holes and/or trenches of the unitary glass structure are filled, fully or partially, with electroactive material, and the dense glass sublayer serves as a solid electrolyte separator layer or has solid electrolyte separator functionality and the porous glass sublayer(s) serve as electroactive layers.

For instance, in various embodiments a lithium metal battery cell is constructed from a unitary glass structure having a asymmetric architecture, in accordance with the present disclosure. Briefly, the closed-end holes and/or trenches of the first porous sublayer are filled with cathode active material (e.g., of the Li ion intercalating type) and the substrate second major surface, which is dense Li ion conducting sulfide glass, provides the surface for lithium metal plating during battery charging, and is preferably smooth and defect free. In various embodiments a protective layer is formed on the substrate second major surface as an interlayer to thereby enhance interfacial properties between the lithium metal and the glass substrate, and the same or different protective layer composition (e.g., a different protective layer) conformally coats the first substrate surfaces, including the sidewall and bottom surfaces defining the holes and/or trenches. The battery cell may be, wherein a current collecting layer is applied directly onto the protective layer on the second substrate surface (e.g., evaporated Cu metal layer). In such instances, the battery cell is constructed with an “anode free” configuration. In other embodiments, a thin layer of Li metal may be applied onto the layer (e.g., by Li metal evaporation), followed by laying down a current collecting layer (e.g., evaporated Cu metal layer). Particularly suitable cathode active materials of the Li ion intercalating type are lithium metal oxides (e.g., LCO, NMC, NCA, LFP, LNMO and the like). A dry or wet slurry mixture of the cathode active material, along with other material additives such as electronically conductive diluents (e.g., high surface area carbons), organic binders, and ionically conductive additives, including particles of Li ion conducting sulfide glass, may be used to fill the holes/trenches of the porous sublayer (e.g., via vacuum infiltration). Once infiltrated the first major surface may be coated with the slurry as an electroactive overlayer to support current collection and provide additional ampere-hour capacity, and thereafter the electroactive overlayer coated with a current collecting layer (e.g., Al metal, evaporated thereon).

In various embodiments, the cathode electroactive material is a compound of at least one metal and one or more of oxygen and sulfur and phosphorous (e.g., transition metal oxides, transition metal sulfides, and transition metal phosphates). In embodiments, the metal oxide or metal sulfide or metal phosphate active material is a Li ion intercalation material, as is understood in the battery art. In various embodiments, Li ion intercalation compounds (e.g., lithium metal oxides) are particularly well suited as the active material herein because they substantially retain their atomic structure after repeated charging and discharging cycles. Without limitation, particularly suitable transition metals for the metal oxide or metal sulfide or metal phosphate intercalation compounds are Co, Fe, Ni, Mn, Ti, Mo, V, and W. Particular examples include lithium nickel oxide (LNO), lithium nickel cobalt aluminum oxide (NCA), lithium cobalt oxide (LCO) lithium nickel cobalt manganese oxide (NCM), nickel cobalt aluminum manganese oxide (NCAM) and lithium iron phosphate (LFP).

In various embodiments a Li-ion battery cell is constructed from a unitary glass structure having a sandwich architecture, in accordance with the present disclosure. The sandwich structure has a first and second porous sublayer with holes and/or trenches that are filled with cathode and anode active material, respectively (i.e., the holes/trenches in the first porous sublayer filled with cathode active material, and anode active material for the second porous sublayer). For benefit, the substrate first and second major surfaces may be coated with a protective layer, including the sidewall and bottom surfaces of the holes/trenches, as described above and in more detail herein below. The protective layer composition for the first and second substrate surfaces may be the same or different. The first porous sublayer may be filled with cathode active material of the Li ion intercalating type and the second porous sublayer may be filled with anode active material of the Li ion intercalating type (e.g., graphite, silicon and combinations thereof and the like); for example, the holes/trenches filled using vacuum infiltration of an active material slurry. Electroactive overlayers composed of cathode active material or anode active material may be applied onto the first and second major surfaces, respectively, followed by deposition of current collecting layers (e.g., Cu metal layer onto the anode active overlayer and Al metal onto the cathode active overlayer).

In another aspect methods for making a Li ion conductive sulfide glass unitary structure of the present disclosure are provided. In various embodiments the methods involve processing a substantially flat and dense Li ion conducting sulfide glass solid electrolyte substrate using inventively modified microfabrication techniques employed in the semiconductor industry. In various embodiments etching solutions specifically formulated for wet etching sulfide electrolytes are disclosed herein. Also provided are lithographic techniques and masking methods for patterning a sulfide solid electrolyte with anisotropic closed-end holes and trenches, including photoresist formulations and methods for application and removal for sulfide solid electrolytes.

In yet other aspects, methods for making a separator electrode assembly and battery cell are provided. In particular, the methods involve processing a Li ion conductive sulfide glass unitary structure of the present disclosure as the basic building block around which the separator electrode assembly and battery cell are fabricated.

### BRIEF DESCRIPTION OF THE DRAWINGS

FIGS. 1A-B illustrate a unitary Li ion conducting sulfide glass solid electrolyte structure having a asymmetric architecture and in the form of a substantially flat monolithic substrate having first and second major opposing surfaces, top-down and cross sectionally, respectively, in accordance with various embodiments.

FIGS. 2A-B illustrate unitary glass structure having a asymmetric architecture with discrete trenches instead of closed-end holes, top-down and cross sectionally, respectively, in accordance with various embodiments.

FIG. 3 illustrates in top-down view a unitary glass structure that is bi-modal and composed of first and second holes each having a different hole diameter in accordance with various embodiments.

FIGS. 4A-B illustrate a unitary structure having asymmetric architecture with a multi-modal porous sublayer, top-down and cross sectionally, respectively, in accordance with various embodiments.

FIGS. 5A-B illustrate unitary Li ion conducting sulfide glass solid electrolyte structure having a sandwich architecture, top-down and cross sectionally, respectively, in accordance with various embodiments.

FIG. 6A illustrates a unitary Li ion conducting sulfide glass structure composed of unitary structure having a conformal protective layer covering a major surface, sidewall and bottom surfaces, in accordance with various embodiments.

FIG. 6B illustrates a unitary structure having a sandwich architecture coated with a protective layer, in accordance with various embodiments.

FIG. 7 illustrates a battery cell built using asymmetric unitary structure in accordance with various embodiments.

FIG. 8 illustrates a Li ion battery cell in accordance with various embodiments built from a Li ion conducting unitary structure having a sandwich architecture.

### DETAILED DESCRIPTION OF SPECIFIC EMBODIMENTS

Reference will now be made in detail to specific embodiments of the disclosure. Examples of the specific embodiments are illustrated in the accompanying drawings. While the disclosure will be described in conjunction with these specific embodiments, it will be understood that it is not intended to limit the disclosure to such specific embodiments. On the contrary, it is intended to cover alternatives, modifications, and equivalents as may be included within the spirit and scope of the disclosure as defined by the appended claims. In the following description, numerous specific details are set forth in order to provide a thorough understanding of the present disclosure. Embodiments of the present disclosure may be practiced without some or all of these specific details. In other instances, well known process operations have not been described in detail in order not to unnecessarily obscure the present disclosure.

When used in combination with “comprising,” “a method comprising,” “a device comprising” or similar language in this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

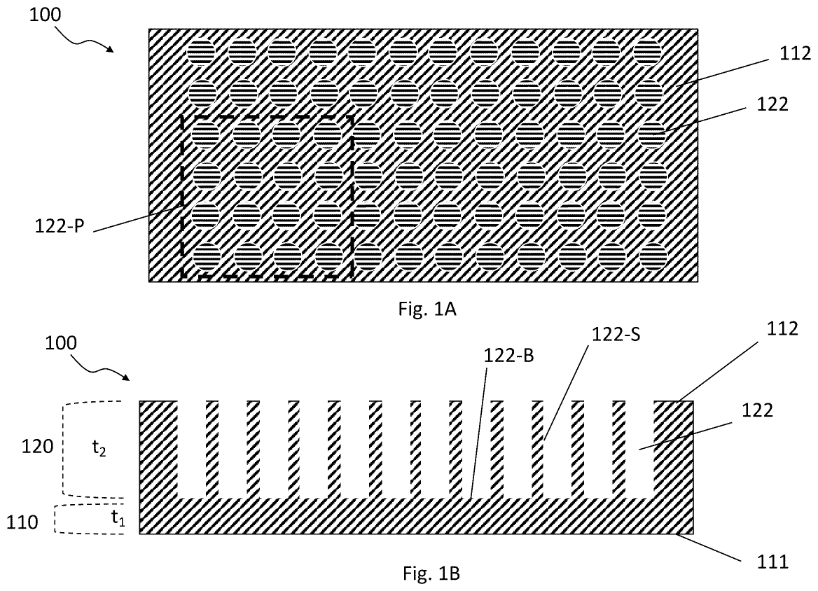

In FIGS. 1A-B there is illustrated a unitary Li ion conducting sulfide glass solid electrolyte structure 100 having an asymmetric architecture and in the form of a substantially flat monolithic substrate having first and second major opposing surfaces 111/112, in accordance with various embodiments of the present disclosure. FIG. 1A, illustrates a top-down view of structure 100 depicting substrate first major surface 111, and in FIG. 1B structure 100 is depicted in cross sectional view. Structure 100, for example substrateless and freestanding, can be engineered using microfabrication techniques of the present disclosure to have dense glass portion 110 characterizable as a dense sublayer and porous glass portion 120 characterizable as a porous glass sublayer.

With reference to FIG. 1B, dense glass portion 110 is a layer-like region wholly composed of Li ion conducting sulfide glass, and characterizable as a sublayer with thickness t₁. Generally, sublayer 110 is substantially devoid of pores having a dense glass surface 111, which is preferably smooth and free of defects and flaws, including pits and divots. Porous glass portion 120, similarly characterizable as a sublayer, can have a precisely controlled porous microstructure that, in various embodiments, has been processed by etching and lithography methods of the present disclosure, and, in particular, porous sublayer 120 may include a plurality of discrete substantially vertical closed-end holes 122 extending from substrate surface 112 into a depth that effectively defines thickness (tz) of sublayer 120. As illustrated in the particular embodiment of FIG. 1B, holes 122 are discrete, substantially cylindrically shaped and have a closed-end bottom 122-B meaning that they do not penetrate through the substrate (between surfaces 112 to 111) to create a through-hole. The holes are also highly anisotropic with substantially vertical sidewalls 122-S and a characteristic diameter Dₕ that may vary with depth, or, in other embodiments, remain substantially constant (as illustrated). Moreover, holes 122 are laterally closed in that the sidewalls fully surround the hole. With reference to FIG. 1A, substrate surface 112 may be characterized as having a surface hole pattern 122-P, which, in various embodiments is a substantially periodic regular array of closed-end spaced-apart substantially circular shaped holes. In various embodiments the surface hole pattern is unimodal (as illustrated in FIG. 1), or bi-modal, or multi-modal and the closed-end holes 122 are engineered with diameters or planar dimensions suitable for receiving and accommodating electroactive material (e.g., cathode active material) in a manner that allows the electroactive material (e.g., cathode active material) to be electrochemically oxidized and reduced during charge and discharge in a battery cell.

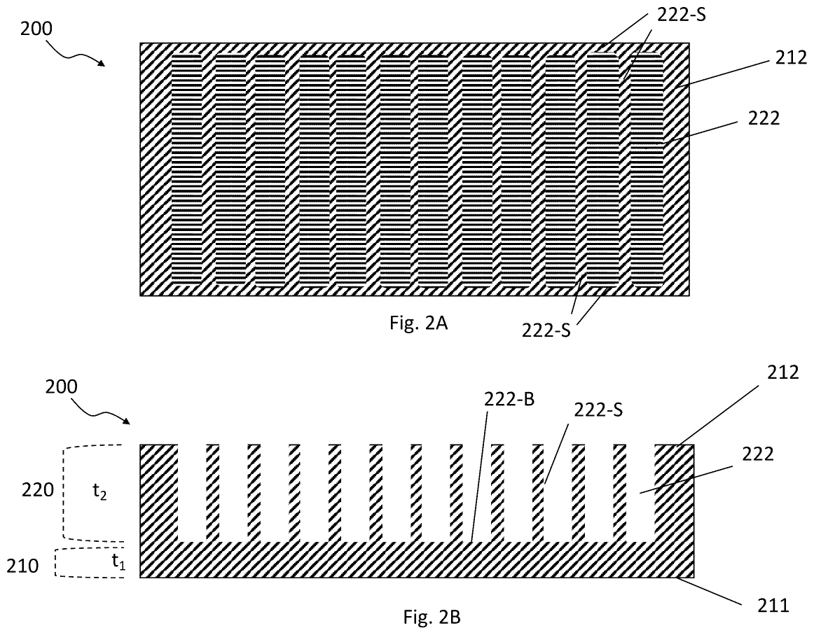

While substantially cylindrical holes are depicted in FIGS. 1A-B, a non-exhaustive variety of hole patterns are contemplated for the porous sublayer, including multi-modal varieties and trenches, and laterally connected holes. Other parameters include hole or trench density (number/mm²), planar shape (e.g., circular) and hole dimension(s) and depth, as well as variations of shape and dimension with depth. By way of non-limiting example, a few representative options are described with reference to FIGS. 2-4.

In FIGS. 2A-B, there is illustrated a unitary glass structure 200 having an asymmetric architecture with discrete trenches 222 instead of closed-end holes. Structure 200 is shown in top-down view in FIG. 2A and cross sectionally in FIG. 2B. Features numbered in FIG. 1 and having a first numeral of 1 are similarly numbered in FIG. 2 with a first numeral of 2; for instance, first and second substrate surfaces 211/212, trenches 222, trench sidewalls 222-S, trench bottom surface 222-B, dense glass sublayer 210 having characteristic thickness t₁ and porous glass sublayer 220 having characteristic thickness t₂. Trenches 222 regularly repeat in spaced apart fashion. Moreover, the trenches are laterally closed, fully surrounded by solid electrolyte sidewalls 222-S and having a single opening on substrate major surface 212. By definition the trenches are closed-end, and do not penetrate so deep into the substrate as to form a through slot.

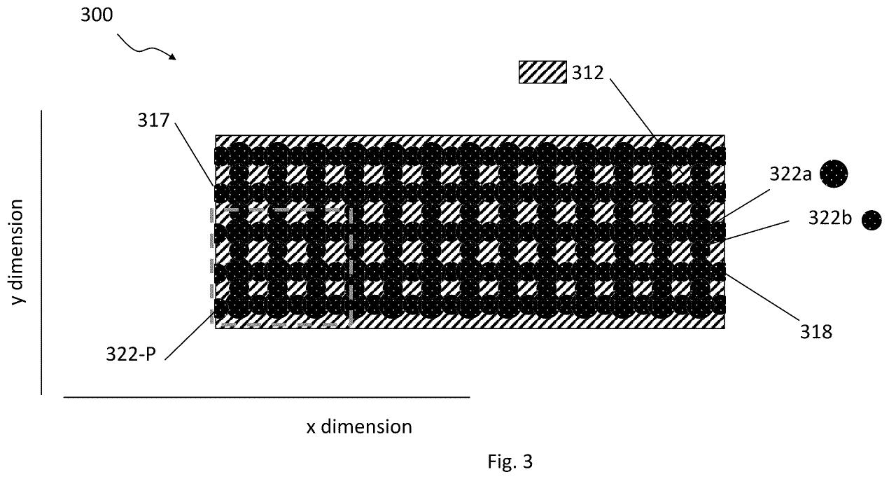

In FIG. 3 there is illustrated in top-down view a unitary glass structure 300 that is bi-modal and composed of first and second holes 322a/322b each having a different hole diameter, wherein diameter of 322a>322b. Another interesting feature of this pattern is that the holes are interconnecting and thus effectively form intersecting trenches in both the x and y dimensions. Moreover, the trenches extend to the substrate side edges 317/318 and therefore have openings at substrate major surface 312 and side edges 317/318, which can be beneficial when filling the trenches with electroactive material, as described in more detail herein below.

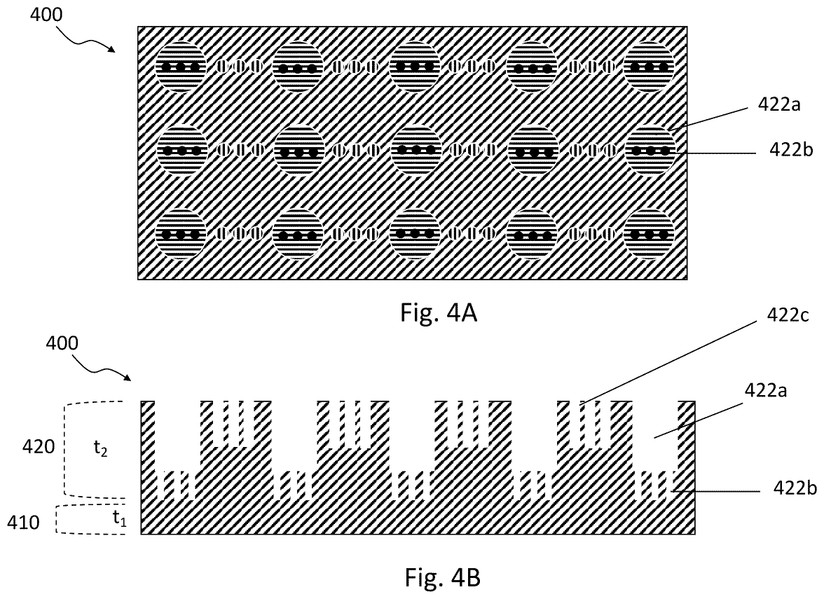

In FIGS. 4A-B a unitary structure 400 having asymmetric architecture with a multi-modal porous sublayer 420 is illustrated top-down and cross sectionally, respectively. The structure includes a bi-modal patterned array of composite hole 422a/b and hole 422c. Composite hole 422a/b can be readily deconvoluted into first hole 422a which is the larger of the holes and second hole 422b, which is a smaller hole that extends deeper into the substrate, and essentially comes in a set of three holes along the x-axis of the substrate, giving rise to a finger-like shape. And hole 422c also patterned in a set of three along the x-axis, is isolated and spaced apart from composite hole 422a/b. In accordance with the present disclosure, composite holes such as hole 422a/b may be formed, as described below, using dry etching methods (e.g., first forming hole 422a followed by dry etching, inside hole 422a, a set of three holes of the 422b type.

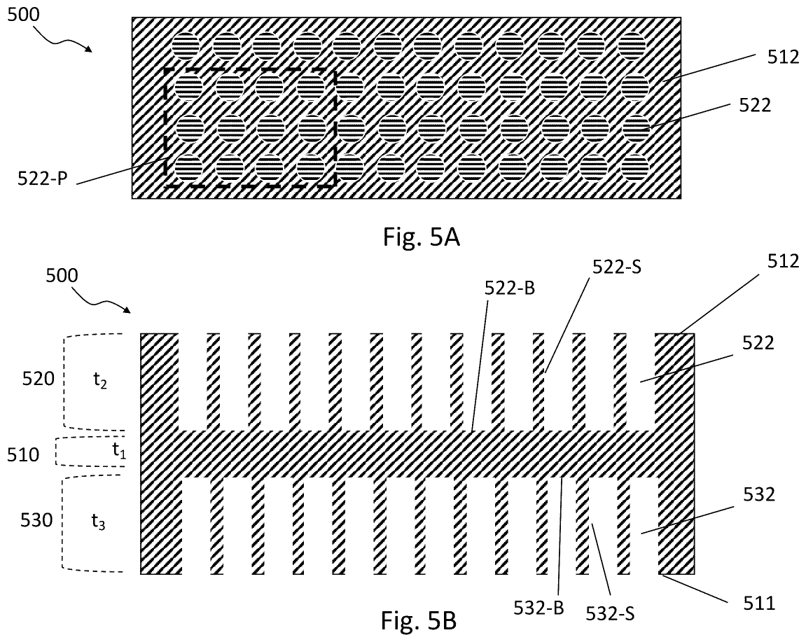

In FIG. 5A-B there is illustrated unitary Li ion conducting sulfide glass solid electrolyte structure 500 having a sandwich architecture in accordance with various embodiments of the present disclosure. The sandwich architecture is similar to the asymmetric architecture described in FIG. 2, and similarly numbered, except that structure 500 has an additional porous sub layer 530 with closed end holes 532. Moreover, dense glass sublayer 510 is sandwiched between sublayer 530 and first sublayer 520. The sandwich architecture is particularly suitable for use in and for making a Li-ion battery cell, wherein holes 520 are filled with cathode active material and holes 530 are filled with anode active material. In various embodiments the hole pattern and porous microstructure of sublayer 520 is different than that of sublayer 530 (e.g., a different total porosity, different thickness, different surface hole pattern, or a different hole shape and size). Further details concerning the fabrication of such a Li-ion battery cell and the sandwich unitary structure from which it is built around, is provided below.

As described herein, in combination with the thickness of the dense glass sublayer, the microstructure and hole pattern of the porous sublayer(s) can be adjusted to target a particular battery application. For instance, a high number density of narrow holes for enhanced battery power, or larger holes for an application in need of a compact or lightweight high energy density cell. The density of holes and their diameter and depth are factors to consider in terms of manufacturability, cost and overall structural strength.

With reference to FIGS. 1-5, in various embodiments dense glass sublayer thickness (t₁) is from 1 to 50 μm, or from 1 to 10 μm or from 5 to 20 μm, or from 20 to 30 μm, or from 30 to 50 μm. Thickness of the porous glass sublayers depend on a number of factors, including the material makeup of the battery cell (e.g., type of active material), target performance in terms of energy and power density and the pore microstructure, including total porosity. Thickness of the porous glass sublayer is generally measured between the substrate surface from which the hole is etched and the length of the deepest extending hole or trench depth. In various embodiments porous glass sublayer thickness ranges from 5 to 1000 um (e.g., 5 to 20 um, or 20 to 50 um, or 50 to 100 um, or 100 to 200 um, or 200 to 500 um, or 500 to 1000 um). The overall porosity of the porous glass sublayers may be in the range from 10% to 90%. Total porosity is oftentimes a tradeoff between mechanical strength of the unitary structure and energy or power density of the battery. In particular embodiments total porosity of the porous sublayer is about 10%, or about 20%, or about 30%, or about 40%, or about 50%, or about 60%, or about 70%, or about 80%, or about 90%.

In various embodiments the closed-end holes have substantially uniform and regular diameters along their length. Typically, the holes have a circular cross section. However, the present disclosure contemplates diameters that vary along the length of the hole. Such a variation may result from the manner by which the hole is formed (e.g., wet etching), and this is described in more detail below. In various embodiments the hole diameter (when circular) or largest planar dimension for a square, oval or other shaped hole is in the range of >50 to 100 um, or >10 to 50 um, or >5 to 10 um, or >1 to 5 um, or less than 1 um (e.g., >100 nm to 1 um). In various embodiments the holes have diameter less than 100 nm (e.g., about 50 to 100 nm). Hole patterns and geometries are generally not limited. The holes are substantially vertical and highly anisotropic (e.g., cylindrical) with length to diameter aspect ratios of at least 2:1, or at least 10:1 (e.g., about 2:1, or about 5:1, or about 10:1, or about 20:1, or about 50:1; or about 100:1, or about 1000:1, or >1000:1). Generally, the number hole density (number of holes/mm²) is related to the total porosity of the porous sublayer. In various embodiments the number hole density is in the range of 1000 holes/mm² to 10,000 holes/mm², hole densities (holes/mm²) greater than 20,000, or greater than 50,000 or greater than 100,000 are also contemplated.

Precise control of the porous sublayer microstructure is achieved by using etching methods of the present disclosure combined with lithography techniques, to create engineered holes and trenches with specific geometric patterns and precise diameters and aspect ratios. In particular, precise geometric hole patterns may be engineered into the unitary glass structure using lithographic masking techniques modified for their applicability to be used for etching Li ion conducting sulfide solid electrolyte substrates.

In accordance with the present disclosure, methods for making unitary glass structures using etching and masking techniques are provided. Generally, the methods involve exposing precisely defined surface regions of a dense Li ion conducting sulfide glass with an etching media. In various embodiments the method involves: i) providing Li ion conducting sulfide glass substrate (e.g., a dense glass monolith) having first and second major opposing surfaces; and ii) exposing precisely defined surface regions to an etching media for a time that is sufficient to form the desired shape and depth. In various embodiments a patterned mask or masking layer may be used to define the etching regions. In preferred embodiments, masking techniques and lithographic processes are employed for exceptional precision and control over the size and location of the holes or trenches.

In accordance with embodiments of the present disclosure the porous sublayers are formed by etching processes, including wet or dry etching methods of the present disclosure, and combinations thereof.

In various embodiments the porous sublayer(s) are engineered into a Li ion conducting sulfide glass monolith (e.g., in the form of a glass sheet) using a wet etching process of the present disclosure. Li ion conducting sulfide glasses are extremely sensitive to moisture. In the presence of water or its vapor, sulfide glasses undergo rapid hydrolysis followed by evolution of hydrogen sulfide gas. In order to reduce the hydrolysis rate, water can be mixed with non-aqueous solvents that don't react with the glass. In particular, mixtures with very low water content can be prepared. In various embodiments, mixtures of water with glymes, for instance DME, are prepared and utilized to decrease the rate of glass hydrolysis. The mixtures having an H₂O to DME ratio of 1:1, 1:5, 1:10, 1:20 1:50, 1:100, 1:200, 1:500, 1:1000 can be used for sulfide glass etching. In other embodiments, mixtures of water vapor and a carrier gas (nitrogen or argon) are used.

It is difficult to control the process of hydrolysis where at least one of the hydrolysis products is a salt poorly soluble in water. This can result in blocking of the glass surface with a solid precipitate and a progressive reduction in the rate of hydrolysis. For instance, hydrolysis of Li₂S—P₂S₅ glasses leads to formation of lithium orthophosphate having low solubility in water. In order to prevent formation of insoluble products, strong inorganic acids such as hydrochloric acid, can be used.

Since hydrochloric acid is soluble in acetonitrile, in various embodiments low concentration solutions of hydrochloric acid in acetonitrile may be used as etching media. After the etching process is complete, the glass surface is rinsed with an excess of acetonitrile, which does not react with sulfide glasses.

In a specific case, organic carbonic acids may be used for etching of sulfide glasses. Formic, acetic, propionic, butyric, oxalic, and malonic acids are particularly suitable.

It was found that liquid formic, acetic, propionic, and butyric acids are miscible with certain aprotic solvents, in particular, glymes and organic carbonates, which are not reactive to sulfide glasses. The solid carbonic acids such as oxalic and malonic acids, have a significant solubility in these solvents. In various embodiments, in order to etch sulfide glasses and adjust the rate of glass hydrolysis (or completely eliminate it) mixtures of formic, acetic, propionic, and butyric acids with glymes, in particular, DME, diglyme or triglyme, or with organic carbonates, in particular, DMC, may be used.

In various embodiments, etching of sulfide glasses occurs in a gaseous phase containing a vapor of carbonic acids or their mixtures with carrier gases (nitrogen or argon). Regulation of the acid vapor pressure is achieved by changing the temperature or adjusting the ratio between the acid in the vapor phase and the carrier gas.

In various embodiments, the chemical etching process may include more than one step. In a particular case, a controlled hydrolysis step can be followed by a glass surface treatment with acidic solutions to dissolve the precipitate(s) consisting of compounds with low solubility in water. Finally, the glass surface is rinsed with aprotic solvents, such as glymes and organic carbonates, in order to remove water and acids from the glass surface.

In various embodiments, a sulfide solid electrolyte substrate is masked and then moved to a container where the unprotected (unmasked) substrate surface is exposed to an etching solution in order to produce a porous glass layer on the surface of a dense glass layer. After removal of the mask, the active components of the etching solution, such as water and acid, are rinsed away with an excess of an aprotic solvent. Wet etching may render a more concave shape along the depth of the hole, and, depending on how the wet etch is applied to the glass surface, may result in an isotropically etched hole.

In various embodiments a dry etching method is provided for creating the porous sublayer, including chemical and physical dry etching processes (e.g., plasma etch). Dry plasma etching may involve exposing glass surface regions to a chemically reactive plasma (a chemical process), leading to volatization and removal of glass reactive species. In various embodiments the dry plasma etch is a physical process performed using ion plasma etching (ion milling) (which is particularly well suited for creating micropore and small mesopore holes). For example, the etching is performed in an argon plasma.

In other embodiments a different physical process may be used that is based on the interaction of laser irradiation with the sulfide glass to create pores of various sizes into the sulfide glass substrate surface(s). This includes utilizing ultraviolet excimer lasers for glass ablation. High speed laser micromachining with high intensity picosecond or femtosecond pulsed lasers may also be used.

In various embodiments, the porous sublayer is created using a patterned structural mask (e.g., fabricated from metals and plastics). Mineral oil may also be used for masking areas that are outside the etching zone but may nonetheless be nearby the etching media. Aluminum, chromium, titanium and nickel masks are particularly suitable for wet etching processes that use a carbonic acid etchant. In particular embodiments, a titanium mask is used in combination with etching media based on acetic, formic, malonic, butyric, and propionic acids; nickel masks are particularly suitable when used in combination with malonic, oxalic, and formic acids; and aluminum masks for propionic and butyric acids.

In various embodiments, the method for making the porous glass sublayer involves lithography processes, including photolithography and electron beam lithography.

Photolithography is a process widely used by the microelectronics industry. The process involves transferring geometric patterns from a photomask to a light sensitive photoresist that is coated onto a substrate surface. In accordance with the present disclosure, photolithographic techniques are generally applied for patterning a hole or trench structure/pattern into an ionically conducting solid electrolyte to create a porous sublayer. Moreover, known photolithography processes cannot be used for Li ion conducting sulfide solid electrolytes due to their high reactivity to moisture. Accordingly, lithography processes provided herein have been specifically developed for creating porous sublayers into inorganic sulfide ion conducting solid electrolytes. In particular, conventional aqueous media that is used for semiconductor processing is replaced herein with dried non-aqueous media throughout all steps of the photolithography processes, and all heat treatments are performed below the glass transition temperature of the Li ion conducting sulfide glass substrate.

In various embodiments, negative photoresists are used in the lithography processes of the present disclosure. In other embodiments, positive photoresists may be used.

Photoresist application onto the surface of the Li ion conducting sulfide glass substrate is performed by dipping, spraying or, in a specific case, by spin coating. The utilized photoresists contain polymerized phenolic resins and dry organic solvents, such as PGMEA, ethyl lactate, or butyl acetate (having b.p. as low as 127° C.). The soft-baking step necessary to remove solvents from the photoresist, as well as hard-baking, which is the final step of the photolithographic process, are done at a temperature lower than T_{g} of the sulfide glass (50° C. lower, 20° C. lower, at least 10° C. lower). After soft-baking, the photoresist (in the areas unprotected with mask) is exposed to short wavelength visible light or UV light. The following step of photoresist removal (in the exposed areas for positive photoresists and in the unexposed areas for negative photoresists) is called developing. In standard lithography, developing is usually performed in aqueous solutions of sodium hydroxide or tetramethylammonium hydroxide (TMAH). Herein developing media based on solutions of TMAH in dry aprotic solvents may be used. In a specific case, the developing solution is a solution of TMAH in acetonitrile. After the photoresist is no longer needed, it is removed by washing in dry NMP. In another case, the photoresist is removed with oxygen plasma.

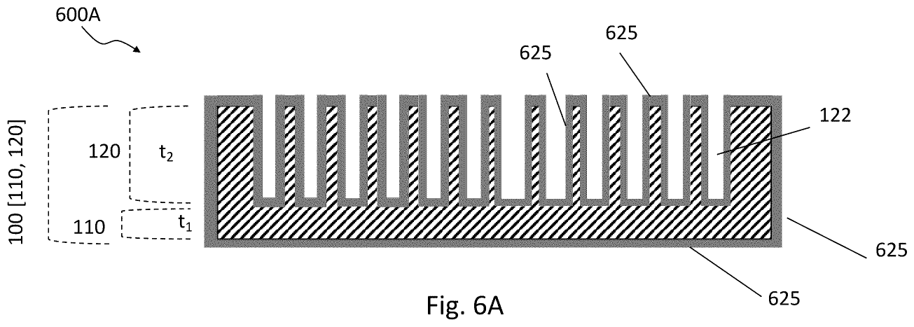

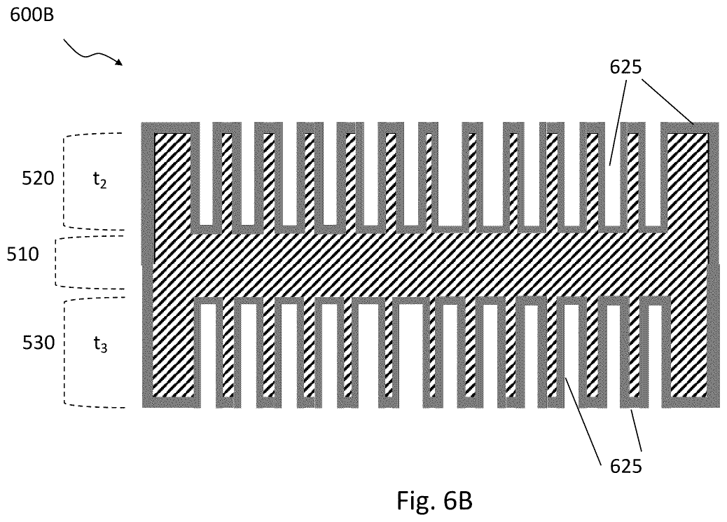

In FIG. 6A a unitary Li ion conducting sulfide glass structure 600A is illustrated composed of unitary structure 100 as illustrated in FIG. 1 having conformal protective layer 625 covering major surface 112 and sidewall and bottom surfaces 122-S/122-B. Protective layer 625 is deposited using a conformal coating technique that is able to coat the sidewall surfaces (e.g., using chemical vapor deposition, and in particular atomic layer deposition, ALD). Thickness of layer 625 is generally less than 1 um, and more typically less than 200 nm, or less than 100 nm, or less than 50 nm or less than 20 nm (e.g., about 10 nm or about 5 nm). Particularly suitable protective layer compositions include Li₂SiO₃, Li₄Ti₅O₁₂, LiTaO₃, LiAlO₂, Li₂O—ZrO₂, LiNbO₃, and metal oxides, such as Al₂O₃, TiO₂, V₂O₅ and others, that, in particular, prevent glass oxidation in contact with cathode active material. Protective layer 625 is applied onto glass structure 100 prior to infiltrating the pore channels or prior to applying a lithium metal layer onto the surface of unitary glass structure face 112.

In FIG. 6B, a unitary structure 600B coated with a protective layer is illustrated. In similar fashion to that described above with reference to protective layer coated unitary structure 600A in FIG. 6A, the surfaces of unitary structure 500 are coated with protective layer 625. In various embodiments the composition of protective layer is same for both porous sublayers 520 and 530. However, it is contemplated that different compositions may be used.

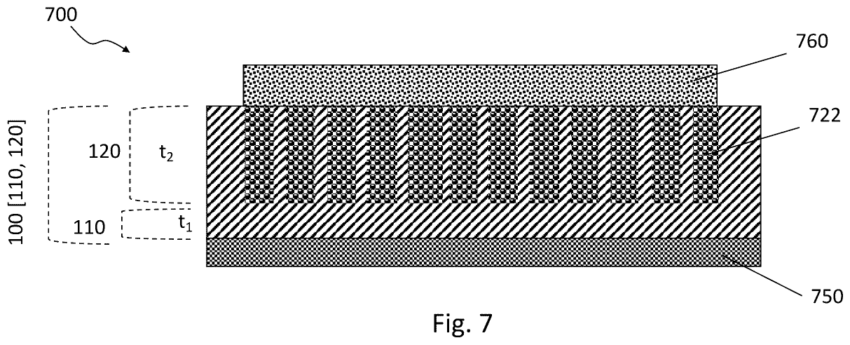

In FIG. 7 there is illustrated battery cell 700 in accordance with various embodiments of the present disclosure. In various embodiments cell 700 is a lithium metal battery cell having lithium metal negative electrode and a positive electrode composed of Li ion intercalating cathode active material. Cell 700 is built using asymmetric unitary structure 100 as illustrated and described in FIG. 1 and having protective layer 625 as described herein with reference to FIG. 6. For the sake of clarity, protective layer 625 is not shown in FIG. 7.

Cell 700 includes cathode active material 722 disposed inside holes 122 and lithium metal layer 760. Surfaces of unitary glass structure 100 are covered by a protective film that enhances or renders interfacial stability between the surfaces of the Li ion conducting sulfide glass and the cathode and anode active material. Cathode active material 722 may be loaded into the holes using vacuum impregnation. For instance, a slurry consisting of active material, polymeric binder and conductive additive (e.g., carbon black or the like) and in some instances also including Li ion conducting sulfide glass particles dispersed in an appropriated liquid solvent (e.g., NMP) is impregnated into the pore channels, and then dried. Multiple impregnation and drying steps may be performed to provide the desired particle loading. When the slurry includes Li ion conducting sulfide glass particles, those particles are generally also surface coated with a protective layer. Generally, battery cell 700 further includes cathode active material overlayer 660, which may be formed onto surface 111 during or after impregnating the holes with cathode active material. A current collector is then generally applied onto the cathode overlayer (e.g., by evaporating a thin layer of Al metal). In various embodiments, lithium metal layer 750 is deposited onto protected surface 111 (e.g., using vacuum evaporation or other suitable physical vapor deposition approach). In other embodiments it is contemplated that the battery cell is built with an anode free configuration, and a current collector is applied directly onto surface 111.

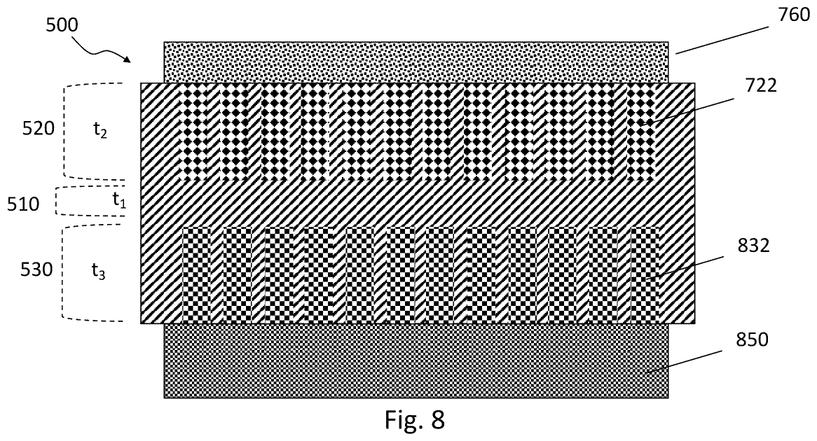

In FIG. 8 there is illustrated battery cell 800 in accordance with various embodiments of the present disclosure that is composed and built from a Li ion conducting unitary structure having a sandwich architecture, as illustrated in FIG. 5 and including a protective layer as illustrated in FIG. 6B. Cell 800 is a lithium ion battery wherein cathode active material 722 is loaded into the holes in sublayer 520 and anode active material 832 is loaded into the holes in sublayer 530. The major surfaces are also covered with electroactive layers. Major surface 112 is covered by a cathode active material overlayer 760 and major surface 111 is covered by an anode active material overlayer 850. In various embodiments both the cathode and anode active materials are of the Li ion type. For example, cathode active material 722 and overlayer 760 of the lithium metal oxide type (e.g., LCO, LFP, NCA, or NMC or the like), and anode active material 832 and overlayer 850 composed of intercalating graphite or silicon or other anode active material, including lithium intercalating titanates.

### CONCLUSION

Although the foregoing disclosure has been described in some detail for purposes of clarity of understanding, it will be apparent that certain changes and modifications may be practiced within the scope of the appended claims. It should be noted that there are many alternative ways of implementing both the process and compositions of the present disclosure. Accordingly, the present embodiments are to be considered as illustrative and not restrictive, and the disclosure is not to be limited to the details given herein.

All references cited herein are incorporated by reference for all purposes.

1-14. (canceled)

15. A method of making a unitary Li ion conducting glass structure, the method comprising:
i) providing a substantially dense and flat Li ion conducting sulfide glass substrate, the substrate having first and second opposing major surfaces;
ii) etching a hole pattern into one or both major surfaces to produce a plurality of discrete spaced-apart closed end holes and/or trenches, wherein the etching involves contacting the substrate surface with an etching media.

16. The method of claim 15 wherein the etching step involves exposing the first substrate surface to a liquid etching solution comprising water as the etchant and a carrier solvent that is inert in direct contact with the glass substrate.

17. The method of claim 16 wherein the carrier solvent is an aprotic organic solvent.

18. The method of claim 16 wherein the carrier solvent is acetonitrile.

19. The method of claim 16 wherein the liquid etching solution further comprises hydrochloric acid.

20. The method of claim 15 wherein the etching step involves exposing the first substrate surface to a liquid etching solution comprising an organic carbonic acid as the etchant and a carrier solvent that is inert in direct contact with the glass substrate.

21. The method of claim 20 wherein the carrier solvent is an aprotic solvent selected from the group consisting of glymes and organic carbonates.

22. The method of step 15 wherein the etching media is a gaseous/vapor etching mixture comprising water as the etchant and a carrier gas that is inert in direct contact with the glass substrate.

23. The method of step 15 wherein the etching media is a gaseous/vapor etching mixture comprising an organic carbonic acid as the etchant and a carrier gas that is inert in direct contact with the glass substrate.

24. The method of claim 22 wherein the carrier gas is one or more of argon gas and nitrogen gas.

25. The method of step 15 wherein the etching media is a plasma as the etchant.

26. The method of claim 25 wherein the plasma is a chemically reactive plasma.

27. The method of claim 25 wherein the plasma is an argon plasma.

28. The method of claim 15 further comprising applying or forming a hole or trench patterned mask onto the first substrate surface prior to the etching step.

29. The method of claim 28 wherein the patterned mask is a structural mask made from a metal or a plastic.

30. The method of claim 28 wherein the patterned mask is a photoresist.

31. The method of claim 30 wherein the photoresist is applied onto the substrate and baked at temperatures below the glass transition temperature of the Li ion conducting sulfide glass substrate.

32. The method of claim 30 wherein the hole pattern is imparted to the photoresist using a non-aqueous solution as developer

33. The method of claim 32 wherein the non-aqueous developer solution comprises tetramethylammonium hydroxide in a dry aprotic solvent.

34-35. (canceled)

36. The method of claim 15, further comprising vacuum impregnating a slurry comprising cathode active material into the holes and/or trenches of one of the major surfaces, thereby forming a battery cell.
